(19) United States
(12) Patent Application Publication
(10) Pub. No.: US 2005/0274814 A1
(43) Pub. Date: Dec. 15, 2005

(54) Selectable coolant heating option for electric vehicle

(76) Inventors: William Schwartz, Pleasant Ridge, MI (US); Upendra Patel, Canton, MI (US); Chendong Huang, Ann Arbor, MI (US)

Correspondence Address: TUNG & ASSOCIATES, 838 WEST LONG LAKE, SUITE 120, BLOOMFIELD HILLS, MI, 48302, US

(21) Appl. No.: 10/866,328

(22) Filed: Jun. 9, 2004

(51) Int. Cl. F02B 63/00

(52) U.S. Cl. 237/28

(57) ABSTRACT

A selectable coolant heating system for a fuel cell electric vehicle is disclosed. The selectable coolant heating system includes a maximum heat button which is connected to a coolant heater that heats a vehicle coolant when the maximum heat button is depressed. The coolant heater is maintained in either a de-activated, non-heating “off” mode or a baseline heating mode unless and until it is activated by depression of the maximum heat button, at which time the heater is activated to a heating level mode or to one of multiple, successively-higher heating level modes, respectively. By subsequent depression of the maximum heat button, the non-heating “off” mode of the coolant heater can be resumed in order to conserve energy and improve vehicle fuel economy.

### FIELD OF THE INVENTION

The present invention relates to heating systems for electric fuel cell vehicles. More particularly, the present invention relates to a selectable coolant heating option for an electric vehicle, according to which selectable heating option a vehicle operator or occupant can selectively activate a coolant heating strategy to heat the interior of the vehicle or conserve energy when such heating of the vehicle interior is not necessary.

### BACKGROUND OF THE INVENTION

Fuel cell technology has been identified as a potential alternative for the traditional internal-combustion engine conventionally used to power automobiles. It has been found that power cell plants are capable of achieving efficiencies as high as 55%, as compared to maximum efficiency of about 30% for internal combustion engines. Furthermore, unlike internal combustion engines, fuel cell power plants emit no harmful by-products which would otherwise contribute to atmospheric pollution.

Fuel cells include three basic components: a cathode, an anode and an electrolyte which is sandwiched between the cathode and the anode. Oxygen from the air is reduced at the cathode and is converted to negatively-charged oxygen ions. These ions travel through the electrolyte to the anode, where they react with a fuel such as hydrogen. The fuel is oxidized by the oxygen ions and releases electrons to an external circuit, thereby producing electricity which drives an electric motor that powers the automobile. The electrons then travel to the cathode, where they release oxygen from air, thus continuing the electricity-generating cycle. Individual fuel cells can be stacked together in series to generate increasingly larger quantities of electricity.

While they are a promising development in automotive technology, fuel cells are characterized by a high operating temperature which presents a significant design challenge from the standpoint of maintaining the structural and operational integrity of the fuel cell stack. Maintaining the fuel cell stack within the temperature ranges that are required for optimum fuel cell operation depends on a highly-efficient cooling system which is suitable for the purpose.

Cooling systems for both the conventional internal combustion engine and the fuel cell system typically utilize a pump or pumps to circulate a coolant liquid through a network that is disposed in sufficient proximity to the system components to enable thermal exchange between the network and the components. In the fuel cell system, the coolant is distributed through a vehicle heating system, in which thermal exchange occurs between the heated coolant from the fuel cell engine and air which subsequently flows into the vehicle cabin or interior through air vents.

In electric vehicles, energy conservation and fuel economy are key considerations. This is particularly true with regard to hydrogen-powered electric vehicles, as hydrogen is not a readily-available fuel in most areas of the world. Because most electric vehicles have a much lower operating temperature than that of internal combustion engines, much more difficulty is encountered in providing sufficient heat to the vehicle cabin using a conventional coolant/air automotive heater core. Since cabin heating is required for both defrosting and customer comfort in cold weather, the use of a supplemental coolant heater is necessary to raise the coolant temperature so that the heater core can function effectively.

The supplemental coolant heater used to raise the temperature of the coolant prior to distribution of the coolant through the heater core consumes large quantities of energy and reduces the range and fuel economy of the vehicle. Therefore, it is desirable to use the coolant heater only when necessary.

Various systems are known in the art for providing a vehicle interior heating option to a vehicle occupant. For example, U.S. Pat. No. 4,591,691 discloses an auxiliary electric heating system for internal combustion engine powered vehicles. The system includes a coolant system in which the conventional engine coolant pump circulates heated coolant from the engine to a heater radiator for transferring heat from the coolant to the vehicle passenger compartment. A thermostatically-controlled electric heating element and an electric pump are located in a branch conduit that receives coolant from the heater radiator. The heating element and electric pump are selectively energizable by the vehicle operator to heat and circulate the engine coolant through a check valve and then through selectively actuated electrically controlled valves which direct it through the heater radiator, the engine or both when the engine is not running. However, the system disclosed in the '691 patent fails to provide a “maximum heat” which can be selectively accessed by a vehicle occupant when needed during vehicle operation and which can be de-activated to conserve fuel cell energy when not needed.

Additional patents which disclose various types of heating systems include U.S. Pat. Nos. 4,520,258; 5,501,267; 6,005,481; 6,037,567; and 6,040,561.

Accordingly, a maximum heat button is needed which enables a vehicle occupant to selectively activate the coolant heater when heating of the vehicle cabin is necessary and de-activate the coolant heater when heating of the vehicle cabin is not necessary. This is similar to a conventional “maximum AC” button which is available in some vehicles and enables a vehicle occupant to maximize the fan speed of a blower to force air across cooling coils in the system at a maximum rate and expedite cooling of the vehicle interior.

### SUMMARY OF THE INVENTION

The present invention is generally directed to a selectable coolant heating system for a fuel cell electric vehicle. The system facilitates maximum heating of the vehicle interior only when selected by a vehicle occupant, thus conserving energy when such heating is not necessary. The selectable coolant heating system includes a maximum heat button which is typically provided on the dashboard or other location inside the vehicle cabin and is used to activate a coolant heater which heats the coolant when the maximum heat button is depressed. Selection of a climate control mode from the climate control selector which includes windshield defrosting is also used to activate the coolant heater for heating the coolant. The coolant heater remains in either a de-activated, non-heating “off” mode or a baseline heating mode unless and until it is activated by depression of either the maximum heat button or selection of a defrost climate control mode, at which time the heater is activated to a heating mode or to one of multiple, successive, upper-level heating modes, respectively. After activation of the coolant heater, the non-heating “off” mode of the coolant heater can be resumed in order to conserve energy and improve fuel economy by depression of the maximum heat button that was previously depressed to activate the heater, or by selection of a non-defrost climate control mode where a defrost mode had been previously selected. The coolant heating strategy may be combined with a variable coolant pump speed scheme to increase the temperature of the vehicle heating system in order to provide a maximum quantity of heat to the vehicle cabin interior.

### BRIEF DESCRIPTION OF THE DRAWINGS

The invention will now be described, by way of example, with reference to the accompanying drawings, in which:

FIG. 1 is a schematic of a coolant distribution system for an electric fuel cell vehicle, with a maximum heat button and a defrost button connected to a coolant heater in the system according to one embodiment of the present invention;

FIG. 2 is a perspective view, partially in section, of a climate control cluster located in a cabin of an electric fuel cell vehicle (not shown), with a maximum heat button and a defrost button provided in the climate control cluster according to the present invention;

FIG. 3 is a schematic of a coolant distribution system for an electric fuel cell vehicle, with a maximum heat button and a defrost button connected to a coolant heater in the system according to another embodiment of the present invention;

FIG. 4 is a schematic which illustrates multiple heating levels of the coolant heater, from “off” to a maximum heating level, by repetitive depression of the max heat button, according to one embodiment of the present invention;

FIG. 5 is a graph in which coolant target temperature is plotted vs. ambient temperature, wherein the coolant target temperature varies with the ambient temperature according to the present invention; and

FIG. 6 is a schematic which illustrates multiple heating levels of the coolant heater, from a baseline heating level to a maximum heating level, by repetitive depression of the maximum heat button, according to another embodiment of the present invention.

### DETAILED DESCRIPTION OF THE INVENTION

The present invention contemplates a selectable coolant heating option which enables an occupant of an electric fuel cell vehicle to selectively expend vehicle fuel for vehicle cabin heating purposes only when maximum heating of the cabin or windshield defrosting is deemed necessary. The selectable coolant heating option includes a maximum heat button which is typically provided in the climate control cluster on the dashboard or in any other accessible location inside the vehicle cabin. The maximum heat button is connected to an electronic control module which, in turn, is connected to a coolant heater, which is selectively activated by the electronic control module to heat the coolant upon depression of the maximum heat button. A climate control mode selector is typically further connected to the electronic control module and the coolant heater, in turn, for selective activation of the coolant heater when a windshield defrost mode is selected.

In one embodiment of the invention, the coolant heater remains in a de-activated, non-heating mode unless and until it is activated by either the maximum heat button or selection of a defrost mode from the climate control mode selector. The non-heating mode of the coolant heater can be resumed in order to conserve energy and improve fuel economy by depression of the maximum heat button that was previously depressed to activate the heater, or by the selection of a non-defrost button where a defrost mode had previously been selected. In one embodiment, the coolant heater can be activated to successively higher levels of heating capacity by repeated depression of the maximum heat button. Depression of the maximum heat button a predetermined number of times returns the coolant heater to the de-activated, non-heating “off” mode. Selection of a defrost mode is typically to automatically activate the coolant heater to a heating level that is suitable to accomplish the windshield defrosting function, where selection of a non-defrost mode returns the coolant heater to the “off” mode.

In another embodiment of the invention, the coolant heater is normally maintained in a baseline heating mode. Repeated depression of the maximum heat button causes activation of the coolant heater to successive heating levels above the baseline heating mode level. The quantity of electrical fuel energy which is consumed by the coolant heater in the baseline heating mode and in the higher heating levels can depend on such parameters as the ambient vehicle temperature and the quantity of energy available to implement the coolant heating function, for example. Depression of the maximum heat button a predetermined number of times returns the coolant heater to the baseline heating mode.

In another embodiment of the invention, the maximum heat button and selection of a defrost mode are used to control the coolant heater and a coolant pump, which pumps the coolant through the system, through an interface with an electronic control module. Upon depression of either the maximum heat button or selection of a defrost mode, the coolant heater is activated from either an “off” mode or a baseline heating mode to one heating level or to a selected one of multiple, successive heating levels (by repetitive depression of the maximum heating button). Simultaneously, the operational speed of the coolant pump is activated from a baseline pump speed to a higher pump speed in order to increase the rate of flow of the heated coolant through the vehicle heating system. Subsequent depression of the maximum heat button a predetermined number of times, or selection of a non-defrost mode, both returns the coolant heater to the “off” or baseline heating mode and slows operation of the coolant pump back to the baseline pump speed.

In still another embodiment of the invention, a timer can also be implemented by the maximum heat button for the purpose of maintaining the coolant heater, or both the coolant heater and the coolant pump, at the activated coolant heating level or at each of the multiple selected heating levels. Accordingly, by depression of the maximum heat button once or multiple times, the coolant heater or both the coolant heater and the coolant pump are activated from the “off” mode or the baseline heating level mode to the selected coolant heating level. The timer then maintains the coolant heater or coolant heater and coolant pump at the selected coolant heating level for a predetermined period of time. After the activation time elapses, the timer automatically terminates operation of the heater or heater and pump, which return to the “off” mode or baseline heating level mode. This timer is typically located inside the electronic control module with which the maximum heat button interfaces.

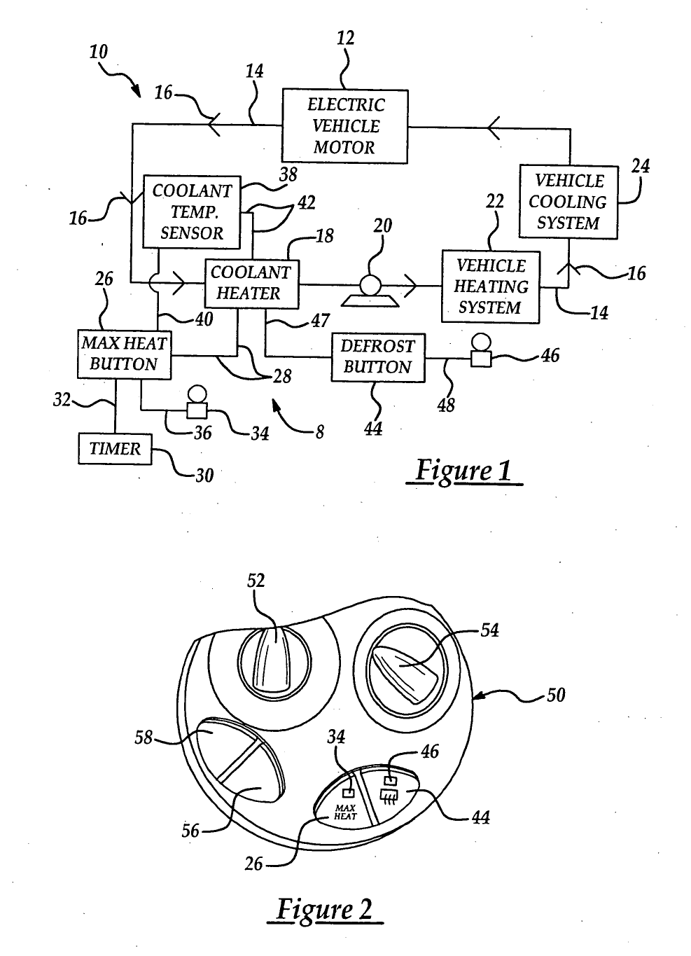

Referring initially to FIGS. 1 and 2, a schematic of a coolant distribution system 10 in the implementation of the present invention is shown. The coolant distribution system 10 includes a coolant distribution line 14 which distributes a liquid coolant 16 through a vehicle cooling system 24, which dissipates heat from the coolant 16, and then through an electric vehicle powertrain motor 12 to cool the powertrain 12. The coolant distribution line 14 further distributes the coolant 16 through a coolant heater 18, which heats the coolant 16 to a heating level, or to one of multiple, successively higher heating levels, as hereinafter described. A coolant pump 20 pumps the heated coolant 16 through a vehicle heating system 22, which includes a heating core (not shown) in which thermal exchange is carried out between the heated coolant 16 and flowing air to heat the air prior to distribution of the air into a vehicle cabin (not shown).

The selectable coolant heating option 8 according to the present invention includes a maximum heat button 26 which is connected to an electronic control module 49, typically through signal transmission wiring 28, which is in turn connected to the coolant heater 18, typically through heater activation wiring 51, to facilitate selective activation of the coolant heater 18 to a coolant heating mode or to a selected one of successively higher coolant heating level modes. A climate control selector 52 is typically further connected to the electronic control module 49, typically through signal transmission wiring 47, which in turn is connected to the coolant heater 18, through heater activation wiring 51, to facilitate selective activation of the coolant heater 18 in a windshield defrost mode. A heat indicator lamp 34 is typically connected to the maximum heat button 26 through lamp wiring 36.

A coolant temperature sensor 38 may be embedded in the coolant distribution line 14 immediately downstream of the coolant heater 18 for sensing the temperature of the coolant 16 at the exit of the coolant heater 18. The coolant temperature sensor 38 is further connected to the electronic control module 49 through sensor wiring 40. In one embodiment of the invention, the coolant temperature sensor 38 is used by the electronic control module 49 to control the operation of the coolant heater 18 so as to maintain the temperature of the coolant 16 as reported by the temperature sensor 38 at a target temperature, as hereinafter further described. A timer 30, typically implemented within the electronic control module 49, may also be activated, by the maximum heat button 26 through signal transmission wiring 28 to terminate further operation of the coolant heater 18 at a particular heating level after a preset period of time has elapsed, as hereinafter further described.

As shown in FIG. 2, the maximum heat button 26 and the climate control mode selector 52 may be provided together on a climate control cluster 50 which is located inside the fuel cell electric vehicle (not shown), such as in the center console of the vehicle, for example. The climate control cluster 50 typically further includes a climate control blower fan speed control dial (not shown), a temperature control dial 54, a cabin air recirculation button 56, an air conditioning activation button 58, a rear window defrost grid activation button 44, and a rear window defrost indicator lamp 46. The heat indicator lamp 34 and the rear window defrost indicator lamp 46 are typically provided on or integrally with the maximum heat button 26 and rear window defrost button 44, respectively. Many variations in the layout of these controls exist in vehicles today and many of the climate control functions can be controlled automatically in some arrangements.

In operation of the selectable coolant heating option 8, coolant 16 is distributed by the coolant distribution line 14 through the vehicle cooling system 24. In the vehicle cooling system 24, heat is dissipated from the coolant 16 preparatory to distribution of the coolant 16 through the electric vehicle powertrain 12 by the distribution line 14. As it passes through the electric vehicle motor 12, the coolant 16 absorbs heat energy to cool the powertrain 12.

The distribution line 14 distributes the heated coolant 16 from the electric vehicle powertrain 12 to the coolant heater 18. In one embodiment of the selectable coolant heating option 8, the coolant heater 18 is normally maintained in an “off” mode, in which the coolant 16 is not heated as it passes through the coolant heater 18 unless and until the maximum heat button 26 is depressed or a defrost mode is selected from the climate control mode selector 52. Therefore, the coolant 16, previously heated by the electric vehicle powertrain 12, is normally pumped by the coolant pump 20, unheated by the coolant heater 18, through the vehicle heating system 22. In the event that the heater activation button 56 is activated and the temperature control dial 54 is turned to the heat mode, heat energy is transferred from the coolant 16 in the vehicle heating system 22 to flowing air which is distributed into the cabin interior of the electric vehicle (not shown) to heat the vehicle interior.

In the event that the climate control mode selector dial 52 is turned to a “defrost” mode, the coolant heater 18 is activated from the “off” mode to a coolant heating mode, in which the coolant heater 18 heats the coolant 16 to a temperature which is sufficient to heat air flowing through the vehicle heating system 22 for effective defrosting of the vehicle windshield. Upon subsequent selection of a non-defrost mode from the climate control mode selector 52, the coolant heater 18 returns to the “off” mode and heating of coolant 16 flowing there through is terminated.

In the event that the maximum heat button 26 is depressed, the coolant heater 18 is activated from the “off” mode to a coolant heating mode, in which the coolant heater 18 heats the coolant 16 to a target temperature which is sufficient to heat air flowing through the vehicle heating system 22 for maximum heating of the vehicle cabin interior. The heat indicator lamp 34 on the maximum heat button 26 is typically illuminated to visually indicate the activation coolant heating mode of the coolant heater 18. After the coolant 16 reaches a preset target temperature, the coolant temperature sensor 38 may automatically terminate further operation of the coolant heater 18.

As long as the maximum heat button 26 remains in the activated coolant heating mode, the coolant temperature sensor 38 may be operable to cycle the coolant heater 18 between the “off” mode and the coolant heating mode to maintain the coolant 16 at the target temperature. Alternatively, the timer 30 may be programmed to automatically terminate operation of the coolant heater 18 after the coolant 16 has been heated for a preset period of time. In either case, upon subsequent depression of the maximum heat button 26, the coolant heater 18 returns to the “off” mode and heating of coolant 16 flowing there through is discontinued.

Operation of the selectable coolant heating option 8 according to another embodiment of the present invention is shown in FIG. 4, wherein the maximum heat button 26 can be used to activate the coolant heater 18 to a selected one of at least three successively higher heating levels. Accordingly, the coolant heater 18 is normally maintained in the “off” mode, as indicated by the numeral 0 in FIG. 4. As shown in step 1 of FIG. 4, upon a first depression of the maximum heat button 26, the coolant heater 18 is activated from the “off” mode 0 to a first heating level 1a. Upon a second depression of the maximum heat button 26 (step 2), the coolant heater 18 is activated to a second heating level 2a. Upon a third depression of the maximum heat button 26 (step 3), the coolant heater 18 is activated to a third heating level 3a.

The first heating level 1a, second heating level 2a and third heating level 3a correspond to heating modes in which the coolant 16 is heated using progressively higher energy levels to increase the speed at which the the coolant 16 achieves it target temperature. In addition, the different heating levels can also be used to implement successively higher coolant 16 temperature targets as measured by the coolant temperature sensor 38. In such a configuration where successively higher temperature targets are implemented with successive heating levels, thermal exchange between flowing air and the heated coolant 16 in the vehicle heating system 22 is maximal at the third heating level 3a and minimal at the first heating level 1a. Upon subsequent depression of the maximum heat button 26 (step 4), the coolant heater 18 returns to the “off” mode 0. It is understood that the coolant heater 18 can be activated to any desired number of heating levels, not limited to the three successively higher heating levels shown with respect to FIG. 4, to provide a selected heating capacity to the interior of the vehicle cabin. Furthermore, the timer 30 may be programmed to limit the time which elapses during each of the heating level modes. For example, the timer 30 may be programmed to maintain the coolant heater 18 at the highest heating level mode for a preset period of time before implementing the next lowest heating level mode.

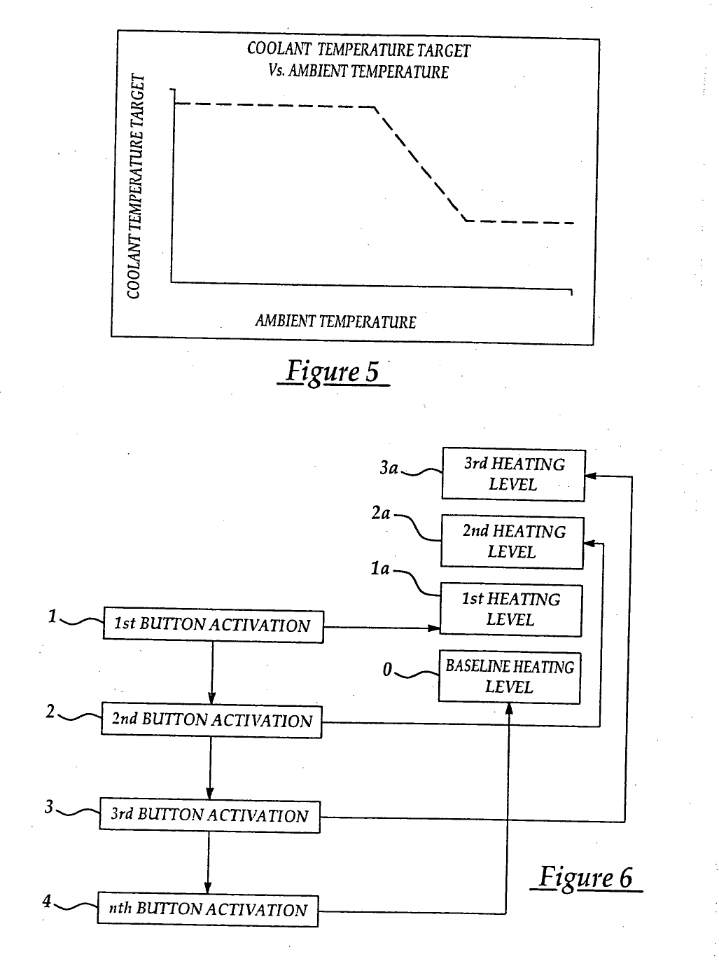

The quantity of electrical energy which is expended to maintain each of the successively higher heating level modes may depend on such factors as the quantity of energy available to perform the heating function, the ambient temperature of the air surrounding the vehicle and whether or not a defrost mode has been selected from the climate control mode selector dial 52, for example. Referring to FIG. 5, the coolant target temperature at each of the successively higher heating levels may remain steady up to a selected ambient temperature, at which point the coolant target temperature, and therefore the quantity of energy necessary to maintain the coolant target temperature, typically decreases.

Operation of a selectable coolant heating option 8 according to another embodiment of the invention is shown in FIG. 6, wherein the coolant heater 18 is normally maintained at a baseline heating level mode, as indicated by the numeral 0 in FIG. 6. As shown in step 1 of FIG. 6, upon a first depression of the maximum heat button 26, the coolant heater 18 is activated from the baseline heating level mode 0 to a first heating level 1a. Upon a second depression of the maximum heat button 26 (step 2), for example, the coolant heater 18 is activated to a second heating level 2a. Upon a third depression of the maximum heat button 26 (step 3), for example, the coolant heater 18 is activated to a third heating level 3a. Upon subsequent depression of the maximum heat button 26 (step 4), the coolant heater 18 returns to the baseline heating level mode 0.

It is understood that the selectable coolant heating option 8 may have the capacity for a greater or fewer number of successively higher heating levels, as deemed necessary, and need not be limited to three heating levels. As described herein above with respect to FIG. 4, the quantity of electrical energy which is expended to maintain the baseline heating level mode, as well as each of the successively higher heating level modes, may depend on such factors as the quantity of energy available to perform the heating function, the ambient temperature of the air surrounding the vehicle and whether or not a defrost mode has been selected from the climate control mode selector dial 52, for example.

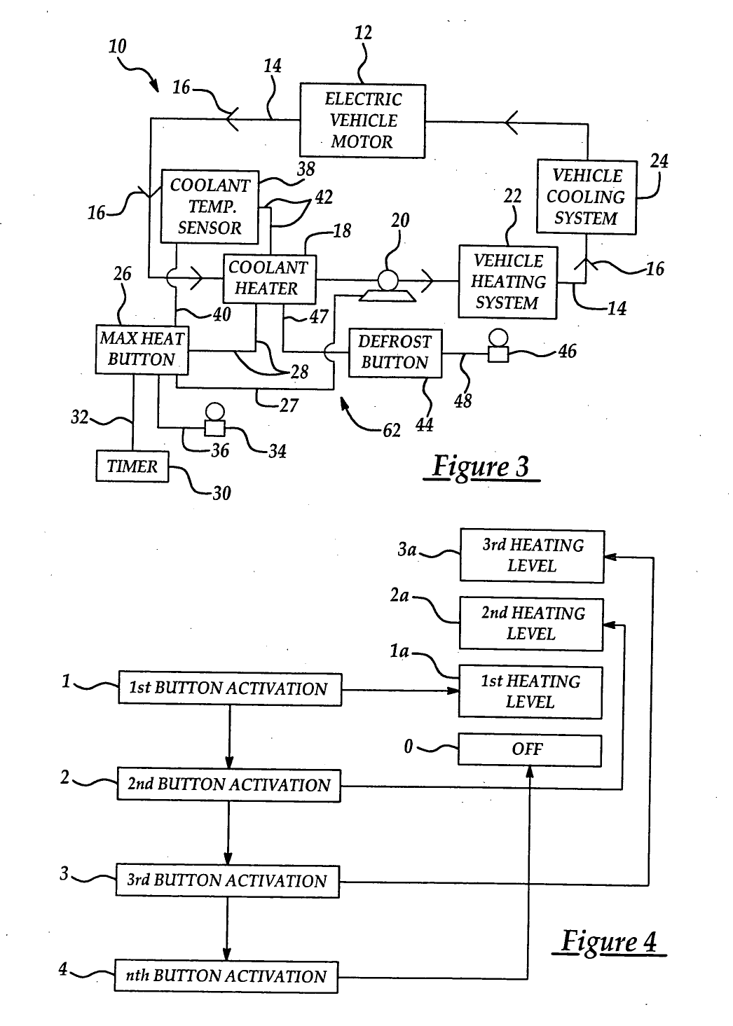

Referring next to FIG. 3, in another embodiment of the selectable coolant heating option, indicated by reference numeral 62, the maximum heat button 26 is connected to the electronic control module 49 through wiring 28. The climate control mode selector dial 52 is likewise connected to the electronic control module 49 through signal transmission wiring 47. Accordingly, by selection of a defrost mode from the climate control selector dial 52, the coolant heater 18 is activated to a windshield defrost heating level from either an “off” mode or a baseline heating level mode to heat the coolant 16. Simultaneously, the operational speed of the coolant pump 20 is increased to increase the rate of flow of the coolant 16 through the vehicle heating system 22. Accordingly, the combined effects of the coolant heater 18 and the pumping action of the coolant pump 20 increase the thermal exchange between the coolant 16 and flowing air in the vehicle heating system 22.

By depression of the maximum heat button 26, the coolant heater 18 is activated to a heating level, or to a selected one of successively higher heating levels, from either the “off” mode or the baseline heating level mode to heat the coolant 16. Simultaneously, the operational speed of the coolant pump 20 is increased to increase the rate of flow of the coolant 16 through the vehicle heating system 22. Accordingly, the combined effects of the coolant heater 18 and the pumping action of the coolant pump 20 increase the thermal exchange between the coolant 16 and flowing air in the vehicle heating system 22.

While the preferred embodiments of the invention have been described above, it will be recognized and understood that various modifications can be made in the invention and the appended claims are intended to cover all such modifications which may fall within the spirit and scope of the invention.

1. A selectable coolant heating system for a vehicle, comprising:
a coolant heater for heating a coolant; and
a maximum heat button operably connected to said coolant heater for selectively activating said coolant heater to a selected coolant heating level.

2. The selectable coolant heating system of claim 1 further comprising a coolant temperature sensor operably connected to said coolant heater for sensing a temperature of the coolant and controlling operation of said coolant heater so as to maintain the temperature of the coolant at a target temperature once the coolant reaches said target temperature.

3. The selectable coolant heating system of claim 1 further comprising a timer operably connected to said coolant heater for limiting operation of said coolant heater at said selected coolant heating level by a selected time interval.

4. The selectable coolant heating system of claim 3 further comprising a coolant temperature sensor operably connected to said coolant heater for sensing a temperature of the coolant and controlling operation of said coolant heater so as to maintain the temperature of the coolant at a target temperature once the coolant reaches said target temperature.

5. The selectable coolant heating system of claim 1 further comprising a defrost mode selector operably connected to said coolant heater for selectively activating said coolant heater.

6. The selectable coolant heating system of claim 5 further comprising a coolant temperature sensor operably connected to said coolant heater for sensing a temperature of the coolant and controlling operation of said coolant heater so as to maintain the temperature of the coolant at a target temperature once the coolant reaches said target temperature.

7. The selectable coolant heating system of claim 5 further comprising a timer operably connected to said coolant heater for limiting operation of said coolant heater at said selected coolant heating level by a selected time interval.

8. The selectable coolant heating system of claim 7 further comprising a coolant temperature sensor operably connected to said coolant heater for sensing a temperature of the coolant and controlling operation of said coolant heater so as to maintain the temperature of the coolant at a target temperature once the coolant reaches said target temperature.

9. A selectable coolant heating system for a vehicle, comprising:
a coolant heater for heating a coolant;
a coolant pump for pumping the coolant from said coolant heater; and
a maximum heat button operably connected to said coolant heater for selectively activating said coolant heater to a selected coolant heating level and to said coolant pump for operating said coolant pump at a selected pump speed.

10. The selectable coolant heating system of claim 9 further comprising a coolant temperature sensor operably connected to said coolant heater for sensing a temperature of the coolant and controlling operation of said coolant heater so as to maintain the temperature of the coolant at a target temperature once the coolant reaches said target temperature.

11. The selectable coolant heating system of claim 9 further comprising a timer operably connected to said coolant heater for limiting operation of said coolant heater at said selected coolant heating level by a selected time interval.

12. The selectable coolant heating system of claim 11 further comprising a coolant temperature sensor operably connected to said coolant heater for sensing a temperature of the coolant and controlling operation of said coolant heater so as to maintain the temperature of the coolant at a target temperature once the coolant reaches said target temperature.

13. The selectable coolant heating system of claim 9 further comprising a defrost mode selector operably connected to said coolant heater and said coolant pump for selectively activating said coolant heater and operating said coolant pump.

14. The selectable coolant heating system of claim 13 further comprising a coolant temperature sensor operably connected to said coolant heater for sensing a temperature of the coolant and controlling operation of said coolant heater so as to maintain the temperature of the coolant at a target temperature once the coolant reaches said target temperature.

15. The selectable coolant heating system of claim 13 further comprising a timer operably connected to said coolant heater for limiting operation of said coolant heater at said selected coolant heating level by a selected time interval.

16. The selectable coolant heating system of claim 15 further comprising a coolant temperature sensor operably connected to said coolant heater for sensing a temperature of the coolant and controlling operation of said coolant heater so as to maintain the temperature of the coolant at a target temperature once the coolant reaches said target temperature.

17. A method of providing a heating option on a vehicle having a vehicle heating system, comprising:
circulating a coolant through said vehicle heating system; and
selectively heating said coolant to a coolant heating level.

18. The method of claim 17 further comprising increasing a speed of circulation of said coolant through said vehicle heating system.

19. The method of claim 17 wherein said selectively heating said coolant to a coolant heating level comprises selectively heating said coolant to a selected one of multiple successively higher coolant heating levels.

20. The method of claim 17 further comprising limiting heating of said coolant by a temperature limit and a time limit, respectively.
